(19) United States
(12) Patent Application Publication
(10) Pub. No.: US 2021/0259161 A1
(43) Pub. Date: Aug. 26, 2021

(54) PLANT GROWTH SUPPORT

(71) Applicant: Mybram Holdings Inc., Côte Saint-Luc (CA)

(72) Inventor: Jack Miller, Côte Saint-Luc (CA)

(21) Appl. No.: 17/179,869

(22) Filed: Feb. 19, 2021

Related U.S. Application Data
(60) Provisional application No. 62/979,469, filed on Feb. 21, 2020.

(51) Int. Cl. A01G 9/12

(52) U.S. Cl. CPC A01G 9/124; A01G 9/128

(57) ABSTRACT

The present document describes a plant growth support, comprising: a stake having an elongated body with a longitudinal axis and having a first end being removably fixable to the ground, a second end having a connecting member being sized and shaped for receiving a rod in said longitudinal axis and at least one connecting member projecting at an angle from the longitudinal axis for receiving a rod, and an anti-tipping member radially extending from the elongated body and being located between the first and second ends for preventing tipping of the stake in the ground; and at least one vertical rod received in one of the connecting members, the vertical rod is adapted to receive at least one of a plant part, a horizontal rod, a trellis, slanted fingers, and an irrigation system part.

### CROSS-REFERENCE TO RELATED APPLICATION

This application claims priority from U.S. provisional patent application 62/979,469 filed Feb. 21, 2020, the specification of which is hereby incorporated herein by reference in its entirety.

### BACKGROUND

### (A) Field

The subject matter disclosed generally relates to plant growth support.

### (b) Related Prior Art

Various types of plant growth support have been developed over the years, including wooden, plastic, and metallic supports for supporting various plants and vegetables, such as tomatoes, peas, cucumbers, flowers, vine-type plants, and the like, during their growth or at certain stages in their life cycle when the stems are tender and liable to break. The plant growth supports known to date generally include many different components thereof, including stakes, various kinds of posts and fasteners, as well as nets, which all together are usually not modulable nor interconnectable and, as such, not easy to use and not especially adapted for growing various type of plants. Moreover, the various components of these plant growth supports are bulky and not convenient for storage.

Prior art patents do not adequately address these problems. For example, U.S. Pat. No. 5,518,333 simply discloses a connector for a studded T-post tube that may be used to provide support for a wire-formed trellis used in plants culture. For its part, U.S. Pat. No. 6,138,407 discloses a cross arm apparatus that may be assembled with a vertical support and additional cross arms to provide structural support in agricultural and other applications. In all cases, these patents do not provide a fully integrated solution addressing the need of a modulable and interconnectable plant growth support which is adapted for growing various type of plants.

It is therefore an object of the present invention to provide a configurable, collapsible, and easy to use and store plant growth support.

Another object of the invention is to provide a plant growth support which is quickly and easily installed without requiring extra component(s) and/or tool(s).

Another object of the invention is to provide a plant growth support without lose wires or strings which can tear or get tangled.

Another object of the invention is to provide a plant growth support that is suitable for cultivating various types of plants, such as climbing and ground-type vine plants.

### SUMMARY

According to an embodiment, there is provided a stake having an elongated body with a longitudinal axis and having a first end being removably fixable to the ground, a second end having a connecting member being sized and shaped for receiving a rod in said longitudinal axis and at least one connecting member projecting at an angle from the longitudinal axis for receiving a rod, and an anti-tipping member radially extending from the elongated body and being located between the first and second ends for preventing tipping of the stake in the ground; and at least one vertical rod received in one of the connecting members, the vertical rod is adapted to receive at least one of a plant part, a horizontal rod, a trellis, slanted fingers, and an irrigation system part.

According to an embodiment, there is provided a plant growth support, comprising a stake comprising an elongated body having a first portion being removably fixable to the ground, and a second portion having a connecting member being sized and shaped for mounting a first rod thereto; and an anti-tipping member surrounding the elongated body between the first and second portions, wherein the anti-tipping member is adapted for preventing tipping of the stake in the ground.

According to an aspect, the plant growth support comprises the rod mounted to the connecting member, wherein the rod is adapted to receive at least one of a plant part, a second rod, a trellis, slanted fingers, and an irrigation system part.

According to an aspect, the plant growth support comprises at least one connecting member projecting at an acute angle relative to the stake and adapted for mounting a second rod thereto.

According to an aspect, the anti-tipping member comprises a body comprising an aperture extending through the body to pass the stake therethrough; and a ground contacting face surrounding the aperture and, wherein the ground contacting surface is adapted to contact the ground and prevent a tipping or pivoting displacement of the stake in the ground.

According to an aspect, the ground contacting face of the anti-tipping member is substantially flat.

According to an aspect, the anti-tipping member comprises radial protrusion extending from the ground-contacting face.

According to an aspect, the aperture of the anti-tipping member has a face adapted to marry a cooperative face of the stake to limit displacement of the anti-tipping member relative to the stake.

According to an embodiment, there is provided a plant growth support system comprising the plant growth support of described herein. The plant growth support system further comprises the first rod to be mounted to the stake; and a mounting member adapted to be mounted to the first rod. The mounting member comprises a first holder compartment adapted to mount the mounting member to a mounting rod; and a second holder compartment adapted to receive and hold an accessory. Each one of the first holder compartment and the second holder compartment comprises a resilient member defining a deformable mouth to insert the mounting rod or the accessory therein.

According to an aspect, the plant growth support system comprises an accessory to be mounted to the mounting member, wherein the accessory is one of an accessory rod, a trellis, a slanted finger, and an irrigation system part.

According to an embodiment, there is provided an anti-tipping member to be mounted to a stake removably fixable to the ground, comprising a body comprising an aperture extending through the body to pass the stake therethrough; and a ground contacting face surrounding the aperture, where the ground contacting surface is adapted to contact the ground and prevent a tipping or pivoting displacement of the stake in the ground.

According to an aspect, the ground contacting face of the anti-tipping member is substantially flat.

According to an aspect, the anti-tipping member comprises a radial protrusion extending from the ground-contacting face.

According to an aspect, the aperture of the anti-tipping member has a face adapted to marry a cooperative face of the stake to limit displacement of the anti-tipping member relative to the stake.

According to an embodiment, there is provided a mounting member comprising a first holder compartment adapted to mount the mounting member to a mounting rod; and a second holder compartment adapted to receive and hold an accessory. The first holder compartment and the second holder compartment comprise a resilient member defining a mouth deformable into a wider mouth to insert the mounting rod or the accessory therein.

According to an aspect, the first holder compartment and the second holder compartments have a corresponding first and second longitudinal directions, with the first longitudinal direction perpendicular to the second longitudinal direction.

According to an aspect, the mouth of one of the first holder compartment and the second holder compartment leads to a holding space, with the mouth narrower than the holding space.

According to an aspect, the mouth of the first holder compartment and the second mouth of the second holder compartment are facing opposed directions.

According to an aspect, one of the first holder compartment and the second holder compartment has a first and second section that are side by side with a clearance in-between allowing the first section to be operated independently from the second section.

According to an aspect, at least one of the holder compartments comprises open ends.

According to an aspect, the mounting member comprises a third holder compartment having a corresponding mouth, wherein the third holder compartment has a longitudinal direction parallel to the longitudinal direction of the second holder compartment, and wherein mouth of the second holder compartment and the mouth of the third holder compartment are facing perpendicularly to each other.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claim. Accordingly, the drawings and the description are to be regarded as illustrative in nature, and not as restrictive and the full scope of the subject matter is set forth in the claim.

### BRIEF DESCRIPTION OF THE DRAWINGS

Further features and advantages of the present disclosure will become apparent from the following detailed description, taken in combination with the appended drawings, in which:

FIG. 1 illustrates a top front perspective view of a stake for a plant growth support, according to an embodiment of the present invention;

FIG. 2 illustrates a front elevation view of a vertical rod with hooks and connectable to the stake illustrated in FIG. 1, according to an embodiment of the present invention;

FIG. 3A illustrates an enlarged top elevation view of an end of a horizontal rod illustrated in FIG. 2 having an aperture receiving a hook of a vertical rod therein, where the aperture and an end of the hook have complementary diamond shapes;

FIG. 3B illustrates an enlarged side elevation view of a hook of a vertical rod, where an end of the hook has a diamond shape;

FIG. 4 illustrates a top front perspective view of an end of a horizontal rod illustrated in FIG. 2 having a circular aperture receiving a vertical rod therein, according to an embodiment of the present invention;

FIG. 5 illustrates a top elevation view of ends of a horizontal rod receiving vertical rod therein, according to an embodiment of the present invention;

FIG. 6 illustrates an enlarged front elevation view of an arrangement of vertical rods cross-linked to horizontal rods, where the horizontal rods are received into the main cavity of the hooks of the vertical rods;

FIG. 7 illustrates an enlarged front elevation view of an arrangement of vertical and horizontal rods, where the horizontal rods have slanted fingers for providing climbing support to a plant, according to an embodiment of the present invention;

FIG. 8 illustrates an enlarged top front perspective view of a horizontal rod provided with drip irrigation nozzles, according to an embodiment of the present invention;

FIG. 9 illustrates an enlarged front elevation view of an arrangement of vertical and horizontal rods, where the vertical and horizontal rods are connected to a trellis by a plurality of hooks;

FIGS. 10A-E are respectively a top perspective, a bottom perspective, a side view, a bottom view and a top view of another embodiment of anti-tipping member;

FIGS. 11A-E are respectively a top perspective view, a bottom perspective view, a side view, a bottom view and a top view of another embodiment of a stake;

FIGS. 12A-G are respectively a top perspective view, a bottom perspective view, a first side view, a second side view, a front view, a top view and a bottom view of another embodiment of a connector member;

FIGS. 13A-F are respectively a top perspective view, a bottom perspective view, a front view, a top view, a bottom view and a side view of another embodiment of a trellis mounting member.

It will be noted that throughout the appended drawings, like features are identified by like reference numerals.

### DETAILED DESCRIPTION

There is disclosed a plant growth support including a stake, vertical and horizontal rods, as well as a trellis which all together may be arranged into various configurations, as it will become apparent hereinafter.

Advantageously, the present invention is collapsible, adjustable, configurable, self-supporting, and tip-resistant in order to facilitate the optimal spacing and aeration for use in supporting plants, such as tomato, vines, trees, raspberry, blueberry, and/or bush-like plants, and facilitating the harvesting of fruits, vegetables and seeds. The present invention also advantageously provides for (i) supporting plants that do not have their own natural support. The weight of a leafy canopy and fruit clusters will often bring the plant's cordon or “arms” down towards the ground unless it receives some form of support; (ii) facilitating harvesting and gardening tasks, such as pruning, irrigating, applying sprays, fertilizing; and (iii) controlling the quality and increasing the yields of plant growth.

Furthermore, the present invention is inexpensive to manufacture as the stake and the various rods can be made with a simple mold or rod extrusion and metal work technology. The present invention is also easy to use due to the modularity and interconnectivity of the components thereof and the simple way of affixing the plants to the plant growth support and/or trellis with fasteners. The assembly and disassembly of the plant growth support is also easy and makes it very portable and storable.

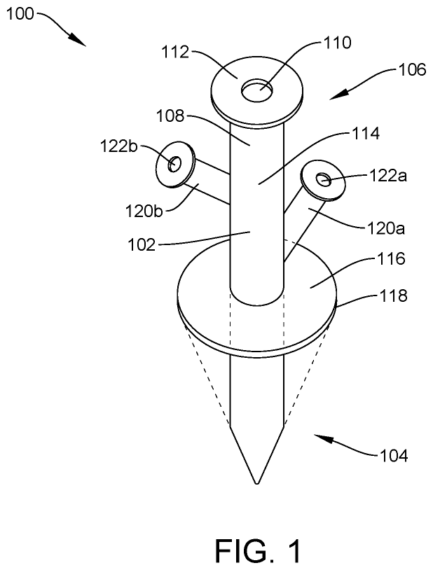

Referring now to the drawings, and more particularly to FIG. 1, a stake 100 is illustrated. In an embodiment, the stake 100 includes an elongated body 102, such as a shaft or a stud, and have a first portion 104, aka mounting portion, and a second portion 106, aka overground portion. The first portion 104 may have various sizes and shapes, such as a bevel shape, a sharp shape, and a screw shape, as long as the first portion 104 may be removably fixed to or anchored in the ground by, e.g., pounding or screwing the stake. Alternatively, the first portion 104 may include any type of connecting element which is removably connectable to another corresponding connecting element already present on the ground.

For its part, the second portion 106 may include at least two (2) connecting members 108 and 120a. For example, as illustrated in FIG. 1, the second portion 106 may include three connecting members 108, 120a, and 120b. The connecting member 108 extends along a longitudinal axis of the elongated body 102, while the connecting members 120a and 120b each extend outwardly from the elongated body 102 and at an angle relative to the longitudinal axis.

In an embodiment, the connecting member 108 may have any size and shape to enable a vertical rod to be connected thereto, as it will become apparent hereinafter. For example, the connecting member 108 may be provided with an aperture 110 (e.g. a female-type connector) sized and shaped to receive a corresponding protruding member (e.g. a male-type connector) of the vertical rod therein. Alternatively, the vertical rod may be provided with a size and shape to receive a corresponding protruding member of the connecting member 108 therein. Also, the connection between the connecting member 108 and the vertical rod may be removably securable together by any means known in the art, such as an interference fit, a locking pin, a quick release mechanism, and the like, to form a plant growth support.

In an embodiment where the connecting member 108 has an aperture 110, an upper portion 112 of the second portion 106 may generally be flattened to provide more structural resistance and surface contact when the stake 100 is fixed or anchored to the ground by pounding. In an embodiment where the stake 100 is screwed into the ground, a portion of the external surface 114 of the second portion 106 may have a shape, such as a hexagonal shape, that enable a corresponding tool to connect thereon to apply a rotating force to the stake 100 for screwing.

In an embodiment, the connecting members 120a, 120b may each have any size and shape to enable the vertical rod to be connected thereto. For example, the connecting members 120a, 120b may each be provided with corresponding aperture 122a, 122b (e.g. a female-type connector) sized and shaped to receive a corresponding protruding member (e.g. a male-type connector) of the vertical rod therein. Alternatively, the vertical rod may be provided with an aperture sized and shaped to receive a corresponding protruding member of one of the connecting members 120a, 120b therein. Also, the connection between the connecting members 120a, 120b and the vertical rod may be removably securable together by any means known in the art, such as an interference fit, a locking pin, a quick release mechanism, and the like, to form a plant growth support.

The connecting members 120a, 120b may project from the elongated body 102 of the stake 100 at any angle, such as at thirty (30), forty-five (45), or sixty (60) degrees relative to the second portion 106 of the elongated body 102, such when connected thereto a vertical rod stands above the ground. Also, the angles of each of the connecting members 120a, 120b may be the same or different. The stake 100 may also be provided with at least one of the connecting members 120a, 120b being adjustable with respect to its angle, such as with a sliding groove and corresponding locking pin, a movable notched or screw tightened mechanism, or any other means known in the art. As it will be appreciated by the person skilled in the art, the connecting members 120a, 120b increase the modularity and interconnectivity of the stake 100 by enabling the connection and configuration of multiple vertical rods to a single stake 100.

In an embodiment, the stake 100 further includes an anti-tipping member 116 which is located between the first and second portions 104 and 106 of the elongated body 102. The anti-tipping member 116 is sized and shaped for preventing a tipping or pivoting displacement of the elongated body 102 while the stake 100 is fixed in or anchored to the ground. Such tipping or pivoting displacement may move the stake and vertical rod(s) connected thereto towards the ground as a consequence of the weight of the vertical rod itself and/or the increasing weight of the growing plant supported by the plant growth support. As the vertical rod moves towards the ground, the stake 100 progressively pivot from its original position, weakening the fixation of the stake 100 with the ground.

The anti-tipping member 116 may have various sizes and shapes as long as the anti-tipping member 116 prevents a tipping or pivoting displacement of the stake 100 in the ground. The anti-tipping member 116 may be located anywhere along the length of the elongated body 102, but preferably mounted such that it provides enough length to the second portion 106 for connecting members 120 and provide enough length to the first portion 104 to be adequately fixed to or anchored in the ground. For example, the anti-tipping member 116 generally defines an annular shape 118 extending radially and substantially perpendicularly from the elongated body 102 of the stake 100. Alternatively, the anti-tipping member 116 may be perforated and have an oblong, square, triangular, or any other shape. The anti-tipping member 116 may extend partially or totally along the circumference of the elongated body 102 and may have a concave or convex shape.

In an embodiment, the stake 100 may be constructed of plastic, metal, resin, and/or any other material known in the art.

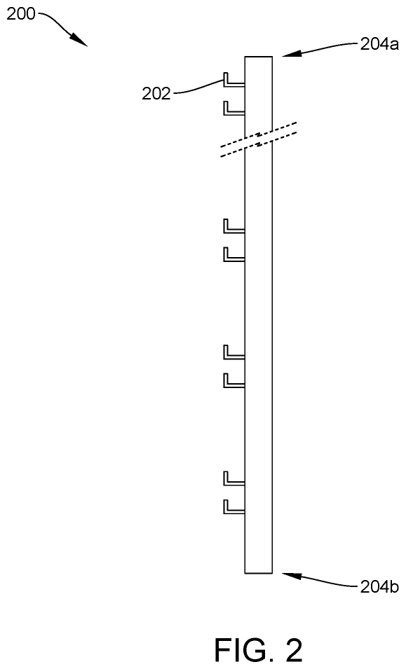

Now referring to FIG. 2, there is shown an embodiment of a vertical rod 200 including a first end 204a and a second end 204b as well as a plurality of hooks 202 disposed along the length of the vertical rod 200, between the first and second ends 204a, 204b thereof. The plurality of hooks may be disposed by pairs along the length of the vertical rod 200. The vertical rod 200 is removably connectable to any of the connecting members 108, 120a, and 120b of the stake 100 by insertion of any of the ends 204, 204b of the vertical rod 200 into any of the corresponding apertures 110, 122a, and 122b of the stake 100. Alternatively, the vertical rod 200 may be connected permanently to any of the connecting members 108, 120a, and 120b so as the vertical rod(s) 200 and the stake 100 form a single, integrally-formed piece.

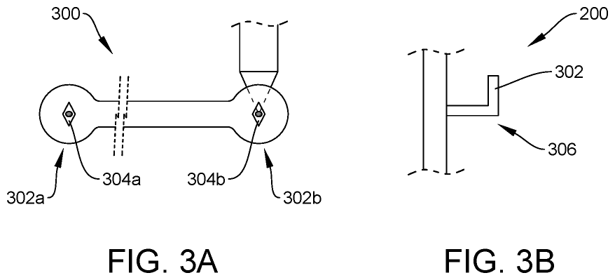

Now referring to FIGS. 3A to 8, there are shown various embodiments of horizontal rods for connection with the vertical rod 200, which all together forms a plant growth support that may hold a trellis, as it will become apparent hereinafter. In an embodiment, as shown in FIGS. 3A-B, a horizontal rod 300 includes first and second ends 302a, 302b as well as diamond-shaped apertures 304a, 304b on each of its corresponding ends 302a and 302b (FIG. 3A). In instance where the horizontal rod 300 has diamond-shaped apertures 304a, 304b, the first and second ends 302a, 302b may generally be flattened in the plane defined by the apertures 304a, 304b. There is also shown an embodiment of the vertical rod 200 with an end 302 of a hook 306 having a size and shape which is complementary to the diamond-shaped apertures 304a, 304b (FIG. 3B).

The horizontal rod 300 is connected to two (2) vertical rods 200, each having the hook 306, by inserting the end 302 of the hook 306 into the corresponding diamond-shaped apertures 304a, 304b of the vertical rod 300. Also, while the diamond-shaped apertures 304a, 304b and the end 302 of the hook 306 are diamond-shaped, the diamond-shaped apertures 304a, 304b and the corresponding end 302 of the hook 306 may have any shape(s), such as a circle, an oval, an oblong, a star, a square, a triangle, and/or any other shape(s). Further, while the horizontal rod 300 has a single diamond-shaped aperture 300a, 300b on each of its corresponding ends 302a, 302b, the horizontal rod 300 may also have any number of apertures located anywhere along the length thereof. This arrangement of the vertical rod(s) 200 cross-linked to the horizontal rod(s) 300 enables the connection of any number of the horizontal rod(s) 200 to any number of the vertical rod(s) 300 so as to form a linear, planar, or longitudinal plant growth support configuration, which may stand at any height above the ground depending on the canopy of the plant being grown. Alternatively, any number of stake(s) 100, vertical rod(s) 200, and horizontal rod(s) 300 may be configured into a zig-zag, square, rectangle, octagon and/or any open or closed area.

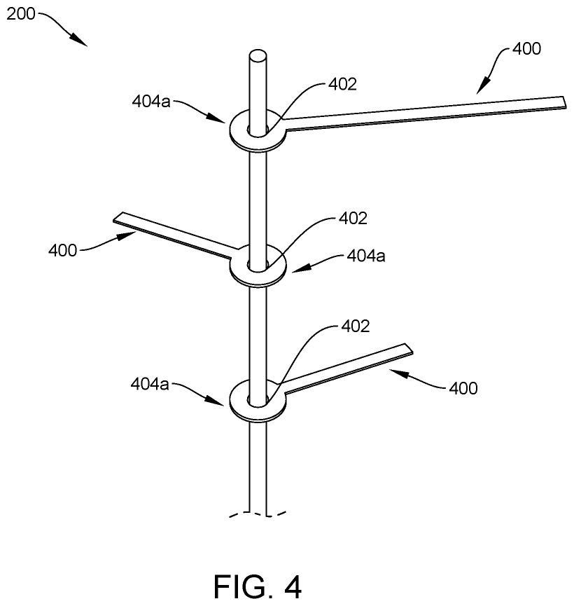

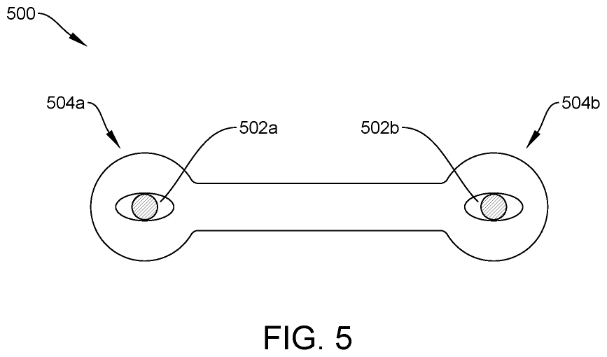

FIG. 4 shows an embodiment of a horizontal rod 400 having a circular or oblong aperture 402 on one on its corresponding end 404a. FIG. 5 shows an embodiment of a horizontal rod 500 having a circular or oblong aperture 502a, 502b on each of its corresponding ends 504a, 504b. The horizontal rods 400, 500 are connected to a vertical rod 200 by inserting the vertical rod 200 into the corresponding circular or oblong apertures 402, 502a, 502b. In configuration where only one end 404a, 504a, or 504b of the horizontal rods 400, 500 is connected to the vertical rod 200, the other end of the horizontal rods 400, 500 is free-standing and projects away from the vertical rod 200. In this case, the downward pressure exerted by the unbalanced horizontal rod(s) 400, 500 keep same securely in place on the vertical rod 200.

In configuration where the ends 504a, 504b of the horizontal rod 500 are each connected to a corresponding vertical rod 200, the cross-linking of any number of horizontal rods 500 with any number of vertical rods 200 may enable the formation of a circumferential or circular plant growth support. Also, while the apertures 402, 502a, 502b are circle-shaped or oblong-shaped, the apertures 402, 502a, 502b may have any size and shape that enables insertion of a vertical rod 200 therein and rotation of the horizontal rods 400 and 500 about the vertical rod 200. Further, while the horizontal rods 400, 500 have one or two (2) aperture(s), respectively, the horizontal rod 400, 500 may also have any number of apertures located anywhere along the length thereof.

For example, the circumferential or circular configuration of a plant growth support may be used with tomato plant in which horizontal rod(s) 400, 500 may be lowered to whatever position desired on any vertical rod(s) 200. Multiple horizontal rods 400, 500 may also be placed onto the same vertical rod 200 to create support at different heights from the ground as well as in any direction around the vertical rod 200 as the center thereof. In this configuration, the plant branches can be supported with fasteners suspended from a vertical and/or horizontal rod 200, 400, and 500. Further, the circumferential or circular configuration of the plant growth support may include a plurality of fasteners connected to any one of the vertical and horizontal rods 200, 400, and 500 and used to removably secure the growing plants so that they remain in place. The fasteners may be reusable and self-fastening, such as Velcro™, tie wire, a bendable plastic-coated wire, and the like.

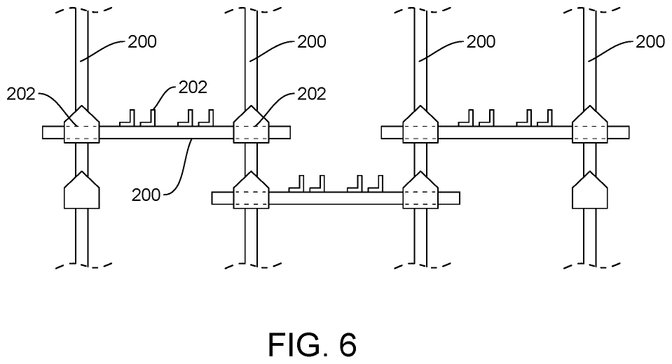

FIG. 6 shows an embodiment of a vertical rod 200 which may be used as a horizontal rod and connected horizontally to two (2) other vertical rods 200 standing in a vertical orientation. Such horizontal connection of the vertical rod 200 may be accomplished in various ways, which all together forms a plant growth support that may hold a trellis. In this case, the vertical rod 200 is free of any aperture on each of its corresponding ends 204a, 204b. As such, the vertical rod 200 may be directly received into the main cavity of a hook from the plurality of hooks 202 of a vertical rod 200 standing in a vertical position. In this arrangement, the disposition of the hooks by pairs along the length of the vertical rod 200 standing vertically provides the clearance required for connecting multiple vertical rods 200 horizontally and proximally to one another. In other words, the vertical rods 200 are attached horizontally to the vertical rod 200 standing vertically by alternating the lower and upper hooks of the pair of hooks.

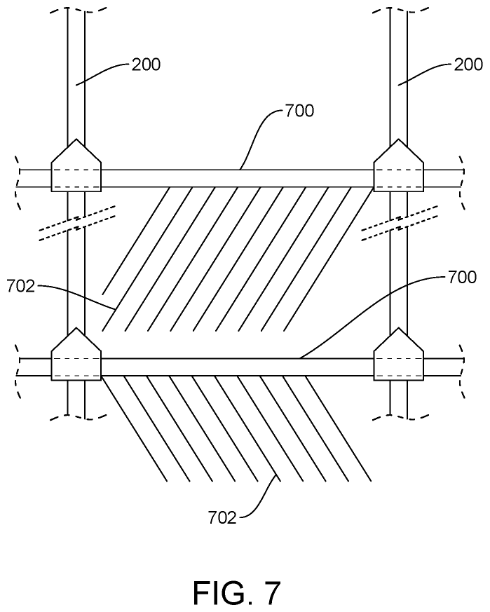

FIG. 7 shows an embodiment of a horizontal rod 700 including slanted fingers 702 which may project upwardly or downwardly therefrom with respect to the ground. The slanted fingers 702 are adapted in size, shape, and orientation (e.g. the angle at which they project) to provide support for a climbing plant so that the climbing plant may reach a next upper horizontal rod. This shortens the distance that the climbing plant has to reach to gain support and access the next upper horizontal rod. The horizontal rod 700 with slanted fingers 702 is modulable and any number of these rod(s) may be located anywhere within any given arrangement of the vertical and horizontal rods.

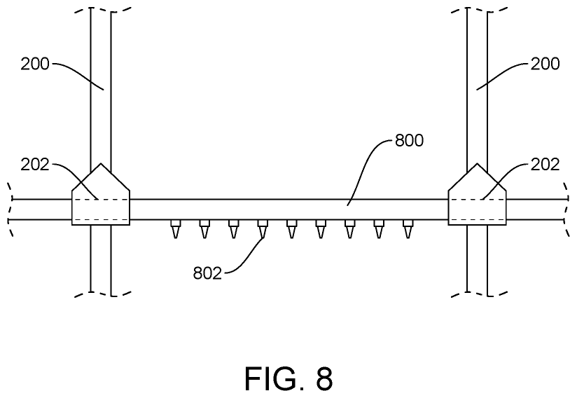

FIG. 8 shows an embodiment of a horizontal rod 800 having a plurality of drip irrigation nozzles 802 that is connectable to a water source to irrigate the ground in order to provide water as needed to the plants with minimal water wastage and evaporation. The horizontal rod 800 with drip irrigation nozzles 802 is modulable and any number of these rod may be located anywhere within any given arrangement of the vertical and horizontal rods. Alternatively, any number and arrangement or configuration of vertical rod(s) 200 having a plurality of drip irrigation nozzles 802 may also be provided for optimal water irrigation.

In an embodiment, any of the vertical rod 200 as well as of the horizontal rods 200, 300, 400, 500, 700, and 800 may be constructed of plastic, metal, wire, resin, and any other material known in the art.

The person skilled in the art will appreciate that the interchangeability and interconnectivity of the vertical and horizontal rods 200, 300, 400, 500, 700, and 800 enables interconnectivity, modularity, and ease of use of the plant growth support.

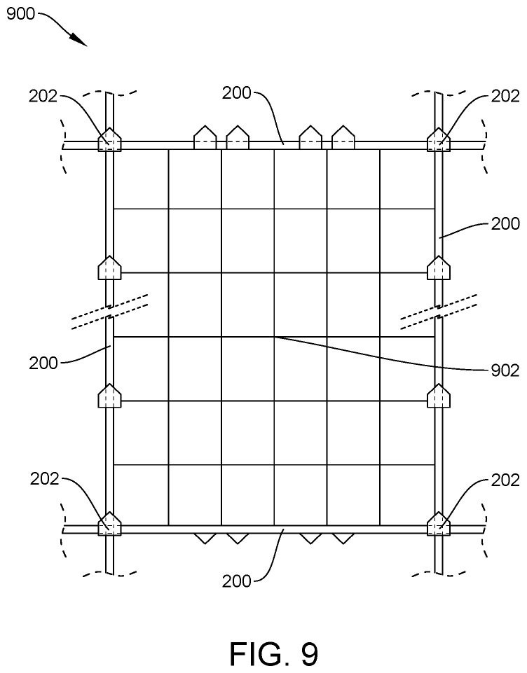

Now referring to FIG. 9, there is shown an embodiment of a trellis 902 that is removably connectable to the plurality of hooks 202 of the vertical rod 200 or to a plurality of hooks of any of the horizontal rods 300, 400, 500, 700, and 800 by a corresponding plurality of openings located along the periphery of the trellis 902. In this arrangement, any plurality of hooks, including the plurality of hooks 202, may be used not only to connect the vertical and horizontal rods 200, 300, 400, 500, 700, and 800 together, but also to support and secure the trellis 902. The trellis 902 has a plurality of fasteners that may be used to removably secure the growing plants attached thereto so that they remain in place on the trellis 902. The fasteners may be reusable and self-fastening, such as Velcro™, tie wire, a bendable plastic-coated wire, and the like. The trellis 902 can be constructed of plastic, woven, fibers, and any other material known in the art.

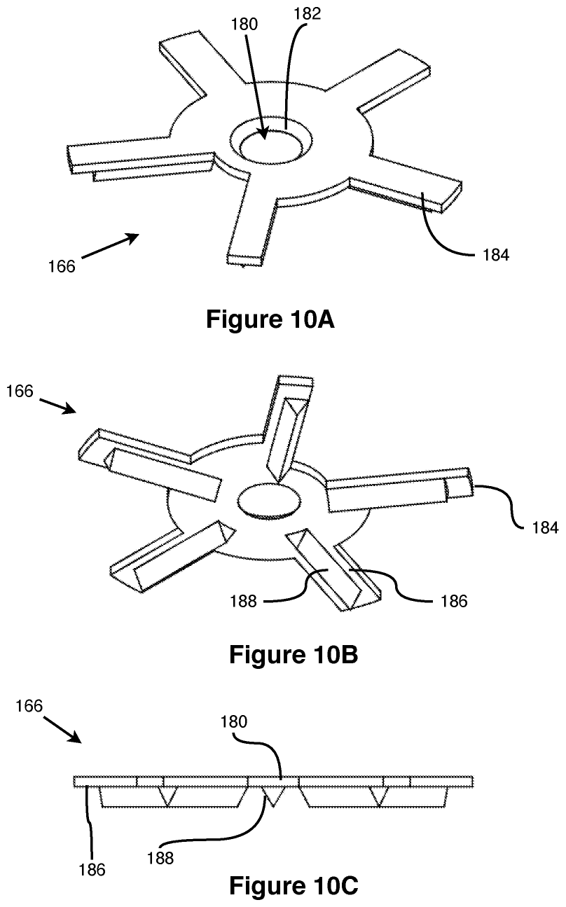

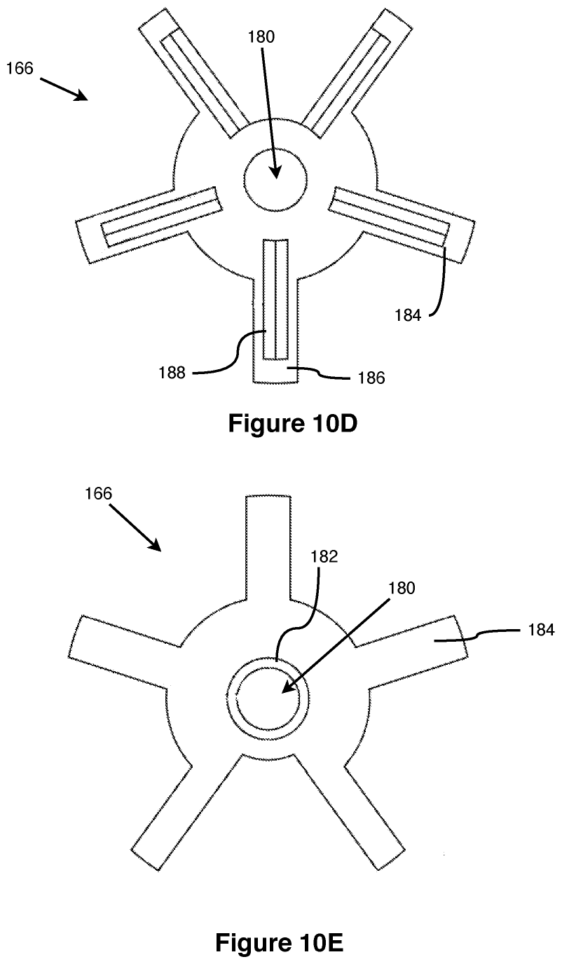

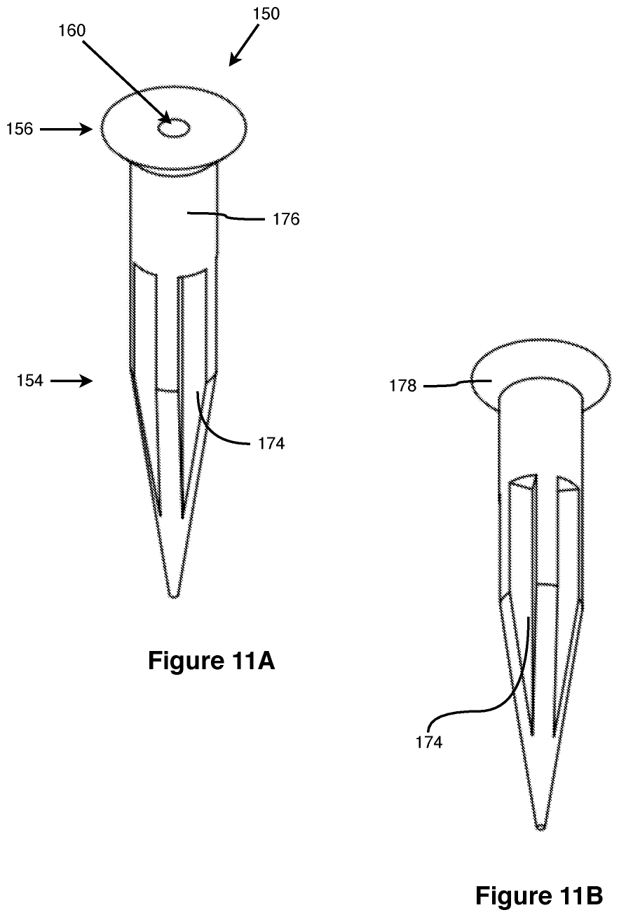

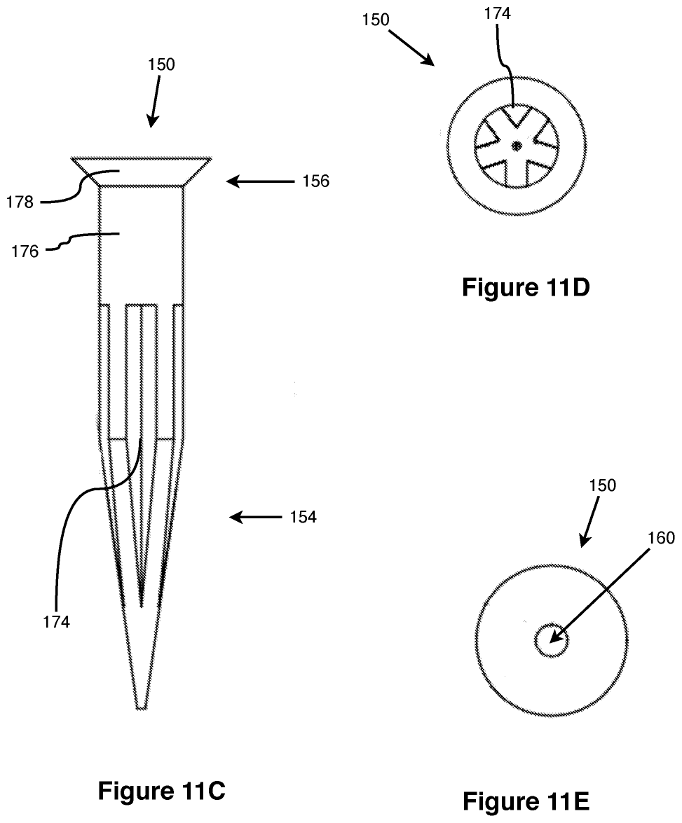

Referring now to FIGS. 10A-E and 11A-E, another embodiment of a stake 150 adapted to mount an anti-tipping member 166 thereto.

The stake 150 comprises a first portion 154 and a second portion 156 with a cylindrical body 176 joining the first portion 104 with the second portion 106. The first portion 154 is adapted to be removably fixed to the ground by, e.g., pounding the stake 150. The first portion 154 has a conic shape with longitudinal channels 174. The second portion 156 comprises an aperture 160 adapted to mount a corresponding protruding member thereto. The second portion 156 further comprises a conical face 178 extending from the cylindrical body 176, whereby the conical face 178 provides a hinderance against upward displacement of an anti-tipping member 166 mounted thereto.

According to alternative embodiments (not depicted), alternative designs of hindrance such as use of nail head like configuration, and washer-like part mounted to the stake 150 using a pin to provide a top hindrance against upward displacement of an anti-tipping member are also contemplated therein

The anti-tipping member 166 for its part comprises a marrying conical face 182 with an aperture 180 adapted for the anti-tipping member 166 to be mounted to the stake 150 and thereby the anti-tipping member 166 to surround the stake 150. The aperture 180 is adapted for the body 176 to extend through therethrough and the conical faces 178, 182 cooperating with each other once mounted to each other. The anti-tipping member 166 comprises a series of radial arms 184 comprising ground-contacting face 186, and preferably a flat ground-contacting face 186, having a rib 188, aka protruding radial member, extending therefrom and adapted both to increase strength of the arms 184 and to contact the ground and prevent movement of the anti-tipping member 166 relative to the ground, and accordingly the stake 150 once installed. Therethrough, the anti-tipping member 166 provides stability to the stake 150.

According to an embodiment as depicted on FIGS. 10A-E, the anti-tipping member 166 as a fan shape that provide clearance between the arms 184 for plants stems.

According to an embodiment, the hub portion of the fan-shaped anti-tipping member 166 is wider between at least two arms 184 to provide space for a main plant stem to grow.

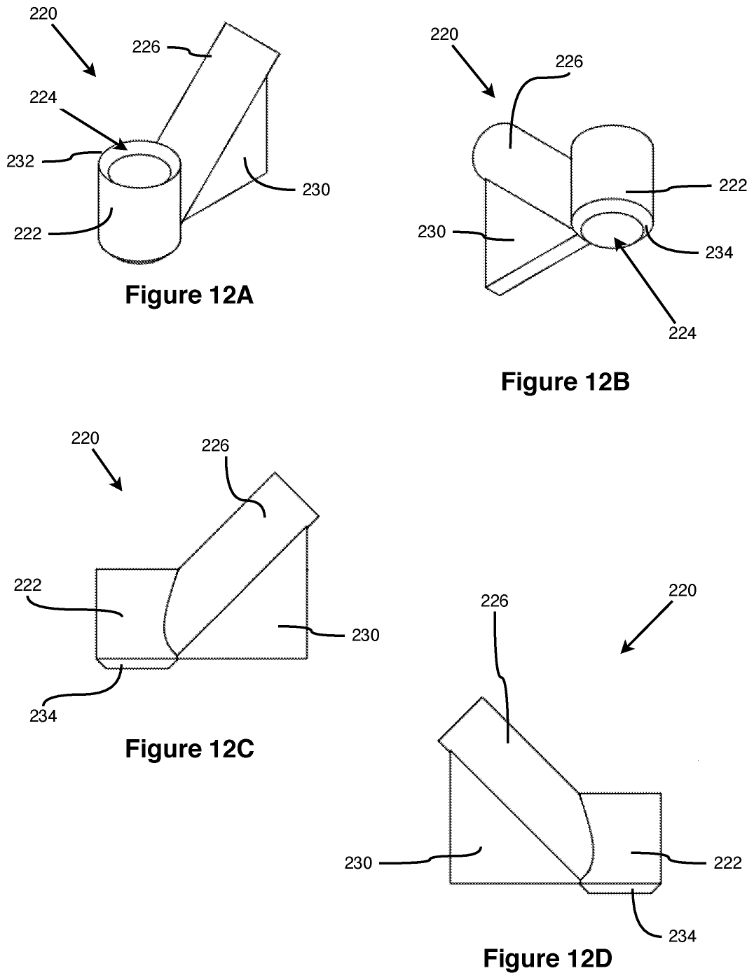

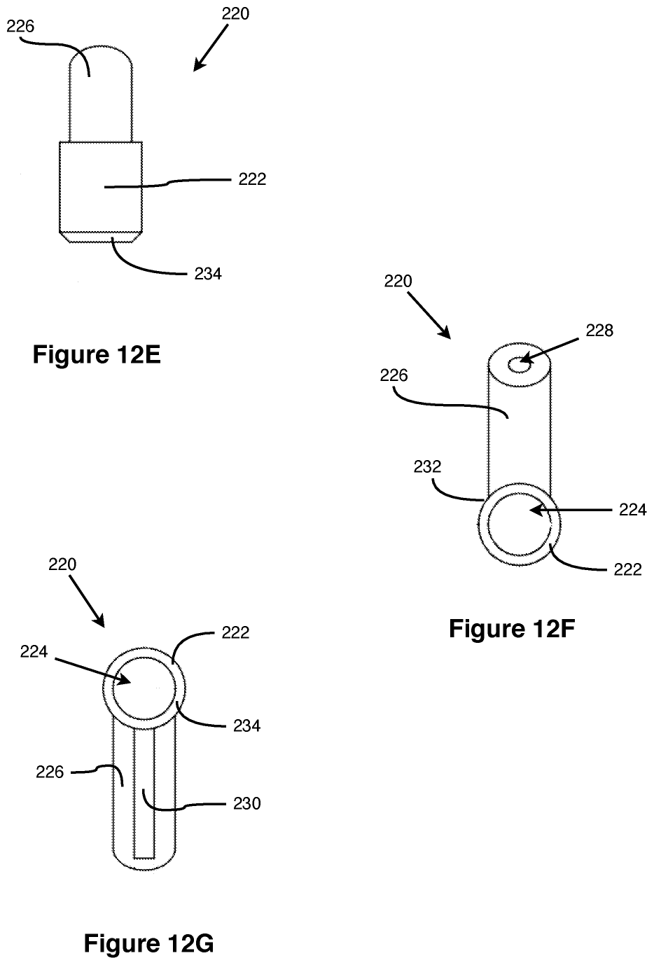

Referring now to FIGS. 12A-G, another embodiment of a connecting member 220 is adapted to be mounted to a cylindrical component, for instance a cylindrical vertical rod similar to vertical rod 200. The connecting member 220 is a unibody member. The connecting member 220 comprises a body 222 having an aperture 224 therethrough for mounting the connecting members 220 to a vertical rod. The body 222 features slandered conical faces 232 and 234 at the top extremity and the bottom extremity of the body, wherein the conical faces 232, 234 are adapted to marry each other when mounting two (2) connecting members 220 on top of each other. The connecting member 220 comprises further a branch 226 extending at an upward angle from the body 222 and ending with an aperture 228 sized and shaped to mount corresponding protruding member such as, e.g., the rod 200. The connecting member 220 further comprises a blade 230 extending from the 222 and downward from the branch 226, wherein the blade 230 is adapted to provide additional resistance to the branch 226 against the weight of a mounted rod and other weight support by the rod.

According to a preferred embodiment, the conical faces 232 and 234 and the conical faces 178 and 180 are sizes and shaped to marry, allowing to place one or more connecting members 220 between the anti-tipping member 166 and the conical face 180 of the stake 150.

According to embodiments, the length of the body may vary from the one having the length corresponding to the height of the branch 226 at the connection to the body 222, or may extend further downward or upward beyond the connection of the branch 226 to the body 222. According to embodiments, the blade 230 may extend to the extremity (top or bottom extremity) of the body 222 from the junction of the body 222 with the branch 226, either under the branch 226 or above the branch 226. According to other embodiments, the body 222 extends beyond its connection to the blade 230.

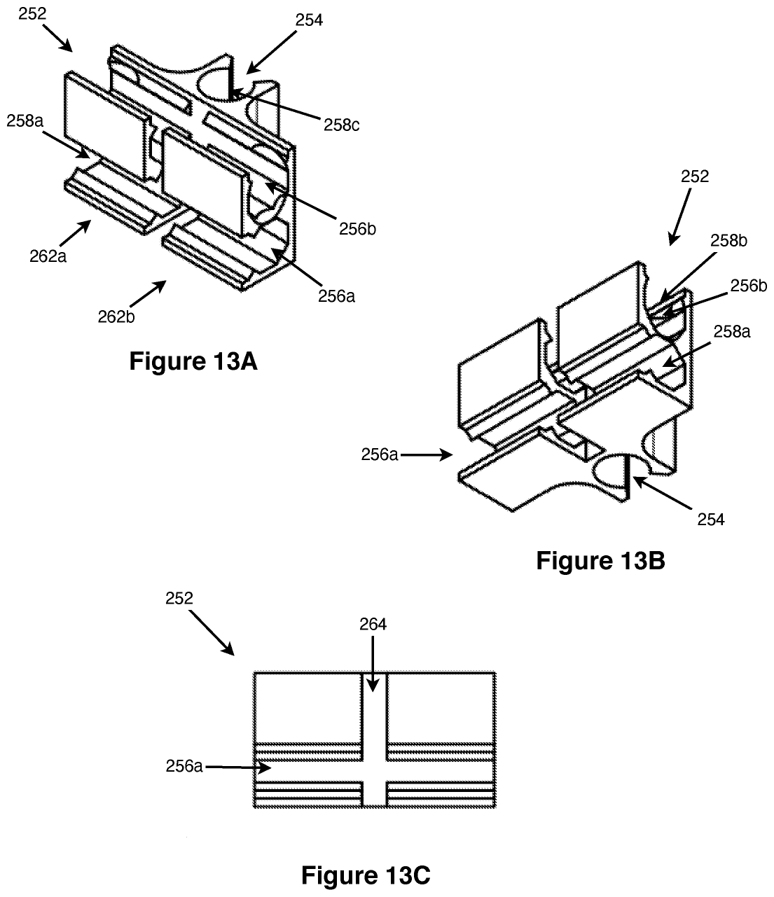

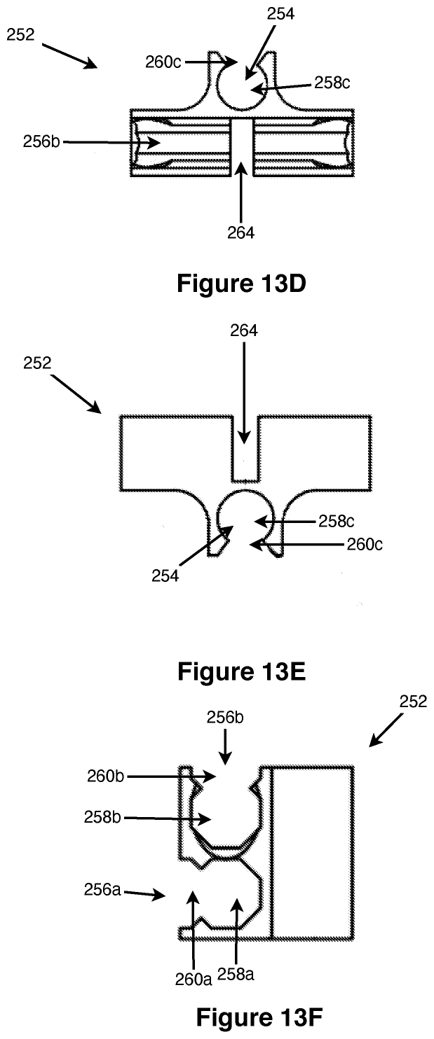

Referring now to FIGS. 13A-F, an embodiment of a trellis mounting member 252 alternative to the hooks 202 (FIG. 2). The trellis mounting member 252 is adapted to be mounted to a rod, e.g., the vertical rod 200, and for accessories, e.g., trellis 902, to be mounted thereto. According to a preferred realization, the accessories are to be mounted to the trellis mounting member 252 perpendicular to the, e.g., mounting rod.

The trellis mounting member 252 comprises a mounting compartment 254 adapted to mount the trellis mounting member 252 to, e.g., a vertical rod, and two (2) accessory holder compartments 256, with each of the holder compartments 256 adapted to mount an accessory, e.g., a rod. The mounting compartment 254 and the holder compartments 256 each comprises an open-ends partial enclosure 258 providing a holding space to hold a rod/accessory with a narrower mouth 260 to pass to mount the, e.g., rod/accessory in the enclosure 258. The trellis mounting member 252 is made of resilient material such that each one of the mounting compartment 254 and holder compartments 256 has a mouth 260 forceable to be open wider to receive a, preferably cylindrical, rod/accessory and that restores to its biased original shape once the rod/accessory has passed the mouth 260.

According to a preferred realization, the trellis mounting member 252 has the mounting compartment 254 on its rear with its mouth 260c facing rearward and the partial enclosure 258c extending in a first longitudinal direction. The trellis mounting member 252 has a first holder compartment 256a on its front with its mouth 260a facing frontward and the partial enclosure 258a extending in a second longitudinal direction perpendicular to the first longitudinal direction. The trellis mounting member 252 comprises a second holder compartment 256b on its front with its mouth 260b facing upward and the partial enclosure 258b extending in the second longitudinal direction. Accordingly, two (2) accessories may be hold, e.g., one extending leftward and one extending rightward to provide thereby a simulation of a continuous trellis through the two accessories.

According to a preferred embodiment, the open-ends partial enclosure 258 are sized and shape to cooperate with the size and shape of the rod and/or accessories for the rod/accessories to be held tightly by the open-ends partial enclosure 258 once inserted.

According to a preferred embodiment, at least one of the holder compartments 256 is divided in two (2) independent aligned sections 262a and 262b with a clearance 264 in-between, wherein the sections 262 are adapted to independently hold an end of a rod whereby the two (2) rods held by the holder compartment 256 are aligned to each other and virtually define a continuous component. Further, the two (2) sections 262 are operable independently from each other, aka a rod may be inserted or removed from a section 262 without affecting the second section, e.g., holding a rod.

According to an embodiment, the components described hereinbefore are provided as a trellis system comprising one or more stakes 100 or stake 150, a corresponding number of anti-tipping members 116 or anti-tipping members 166, and numerous rods 200 to be mounted to the stakes 100, 150. The trellis system may further comprise connecting members 120 or 220, trellis mounting member 252, and accessories such as hooks 202, slanted fingers 702, horizontal rods 800 featuring drip irrigation nozzles 802, and trellis 902 for examples.

While the invention is described generally in terms of use in agricultural trellises or support structures, it should be readily apparent that numerous additional uses for the components of the invention and their method of attachment(s) are possible, including fencing, scaffolding, latticework and other structures.

The present invention will be more readily understood by referring to the following examples which are given to illustrate the invention rather than to limit its scope.

1. A plant growth support, comprising:
a stake comprising an elongated body having a first portion being removably fixable to the ground, and a second portion having a connecting member being sized and shaped for mounting a first rod thereto; and
an anti-tipping member surrounding the elongated body between the first and second portions, wherein the anti-tipping member is adapted for preventing tipping of the stake in the ground.

2. The plant growth support of claim 1, further comprising the rod mounted to the connecting member, wherein the rod is adapted to receive at least one of a plant part, a second rod, a trellis, slanted fingers, and an irrigation system part.

3. The plant growth support of claim 1, further comprising at least one connecting member projecting at an acute angle relative to the stake and adapted for mounting a second rod thereto.

4. The plant growth support of claim 1, wherein the anti-tipping member comprises a body comprising:
an aperture extending through the body to pass the stake therethrough; and
a ground contacting face surrounding the aperture, where the ground contacting surface is adapted to contact the ground and prevent a tipping or pivoting displacement of the stake in the ground.

5. The plant growth support of claim 4, wherein the ground contacting face of is substantially flat.

6. The plant growth support of claim 4, wherein the anti-tipping member further comprises radial protrusion extending from the ground-contacting face.

7. The plant growth support of claim 4, wherein the aperture has a face adapted to marry a cooperative face of the stake to limit displacement of the anti-tipping member relative to the stake.

8. A plant growth support system comprising the plant growth support of claim 1, the plant growth support system further comprising:
the first rod to be mounted to the stake; and
a mounting member adapted to be mounted to the first rod, comprising:
a first holder compartment adapted to mount the mounting member to a mounting rod; and
a second holder compartment adapted to receive and hold an accessory,
wherein each one of the first holder compartment and the second holder compartment comprises a resilient member defining a deformable mouth to insert the mounting rod or the accessory therein.

9. The plant growth support system of claim 8, further comprising an accessory to be mounted to the mounting member, wherein the accessory is one of an accessory rod, a trellis, a slanted finger, and an irrigation system part.

10. An anti-tipping member to be mounted to a stake removably fixable to the ground, comprising:
a body comprising:
an aperture extending through the body to pass the stake therethrough; and
a ground contacting face surrounding the aperture and, where the ground contacting surface is adapted to contact the ground and prevent a tipping or pivoting displacement of the stake in the ground.

11. The anti-tipping member of claim 10, wherein the ground contacting face of is substantially flat.

12. The anti-tipping member of claim 10, further comprising radial protrusion extending from the ground-contacting face.

13. The anti-tipping member of claim 10, wherein the aperture has a face adapted to marry a cooperative face of the stake to limit displacement of the anti-tipping member relative to the stake.

14. A mounting member comprising:
a first holder compartment adapted to mount the mounting member to a mounting rod; and
a second holder compartment adapted to receive and hold an accessory, wherein the first holder compartment and the second holder compartment comprise a resilient member defining a mouth deformable into a wider mouth to insert the mounting rod or the accessory therein.

15. The mounting member of claim 14, wherein the first holder compartment and the second holder compartments have a corresponding first and second longitudinal directions, and wherein the first longitudinal direction is perpendicular to the second longitudinal direction.

16. The mounting member of claim 14, wherein the mouth of one of the first holder compartment and the second holder compartment leads to a holding space, and wherein the mouth is narrower than the holding space.

17. The mounting member of claim 14, wherein the mouth of the first holder compartment and the second mouth of the second holder compartment are facing opposed directions.

18. The mounting member of claim 14, wherein one of the first holder compartment and the second holder compartment has a first and second section that are side by side with a clearance in-between allowing the first section to be operated independently from the second section.

19. The mounting member of claim 14, wherein at least one of the holder compartments comprises open ends.

20. The mounting member of claim 14, further comprising a third holder compartment having a corresponding mouth,
wherein the third holder compartment has a longitudinal direction parallel to the longitudinal direction of the second holder compartment, and
wherein mouth of the second holder compartment and the mouth of the third holder compartment are facing perpendicularly to each other.
